(19) United States
(12) Patent Application Publication
(10) Pub. No.: US 2024/0272302 A1
(43) Pub. Date: Aug. 15, 2024

(54) UE GNSS ASSISTANCE OVER SIDELINK-BASED COMMUNICATION

(71) Applicant: QUALCOMM Incorporated, San Diego, CA (US)

(72) Inventors: Dan VASSILOVSKI, Del Mar, CA (US); Sven FISCHER, Nuremberg (DE); Hong CHENG, Basking Ridge, NJ (US)

(21) Appl. No.: 18/327,645

(22) Filed: Jun. 1, 2023

Related U.S. Application Data
(60) Provisional application No. 63/484,719, filed on Feb. 13, 2023.

(51) Int. Cl. G01S 19/05

(52) U.S. Cl. CPC G01S 19/05; H04W 92/18

(57) ABSTRACT

A method for wireless communication at a first user equipment (UE) and related apparatus are provided. In the method, the first UE obtains global navigation satellite system (GNSS) assistance data for a sidelink positioning session with one or more second UEs via a sidelink message, and calculates, based on the GNSS assistance data for the sidelink positioning session, the position of at least one of the first UE or the one or more second UEs. The first UE further outputs an indication indicative of the calculated position of at least one of the first UE or the one or more second UEs. The method provides a signaling mechanism to support communicating positioning data over a sidelink connection of a UE. It enhances positioning accuracy for UEs operating on sidelink connections and improves the efficiency of wireless communication.

### CROSS REFERENCE TO RELATED APPLICATION(S)

This application claims the benefit of and priority to U.S. Provisional Application No. 63/484,719, entitled “UE GNSS ASSISTANCE OVER SIDELINK-BASED COMMUNICATION” and filed on Feb. 13, 2023, which is expressly incorporated by reference herein in its entirety.

### TECHNICAL FIELD

The present disclosure relates generally to communication systems, and more particularly, to global navigation satellite system (GNSS) assistance over sidelink-based communication for a user equipment (UE) in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to obtain, via a sidelink message, global navigation satellite system (GNSS) assistance data for a sidelink positioning session with one or more second UEs; calculate, based on the GNSS assistance data for the sidelink positioning session, a position of at least one of the first UE or the one or more second UEs; and output an indication of the calculated position of at least one of the first UE or the one or more second UEs.

In an aspect of the disclosure, a method, a computer-readable medium, and an apparatus are provided for wireless communication at a network node. The apparatus may include at least one memory and at least one processor coupled to the at least one memory. Based at least in part on information stored in the at least one memory, the at least one processor may be configured to configure GNSS assistance data for a sidelink positioning session between a first UE and one or more second UEs; and transmit, for the first UE, the GNSS assistance data for the sidelink positioning session between the first UE and the one or more second UEs.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating examples of common signaling and dedicated signaling for GNSS assistance data over a UE-UTRAN (Uu) connection.

FIG. 6 is a diagram illustrating example GNSS data types and example GNSS data elements associated with the GNSS data types.

FIG. 7 is a diagram illustrating an example of GNSS assistance data in SLPP Positioning Assistance Data Exchange, with SLPP over PC5-U SL DRB in accordance with various aspects of the present disclosure.

FIG. 8 is a diagram illustrating an example of GNSS assistance data in SLPP Positioning Assistance Data Exchange, with SLPP over PDCP on SL SRB in accordance with various aspects of the present disclosure.

FIG. 9 is a diagram illustrating an example of GNSS assistance data in SLPP Positioning Assistance Data Exchange, with SLPP over PC5-RRC on SL SRB in accordance with various aspects of the present disclosure.

FIG. 10 is a diagram illustrating an example of GNSS assistance data in SLPP Positioning Assistance Data Exchange, with SLPP over PC5-S on SL SRB in accordance with various aspects of the present disclosure.

FIG. 11 is a call flow diagram illustrating a method of wireless communication in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a UE in accordance with various aspects of the present disclosure.

FIG. 14 is a flowchart illustrating methods of wireless communication at a network node in accordance with various aspects of the present disclosure.

FIG. 15 is a flowchart illustrating methods of wireless communication at a network node in accordance with various aspects of the present disclosure.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

UEs operating over a cellular connection may receive or request GNSS assistance data, enhancing positioning accuracy. However, UEs operating on sidelink connections do not have this capability due to the lack of a defined signaling mechanism to deliver this data. Implementing GNSS assistance data delivery over sidelink connections will fill this technological gap and provide UEs on sidelink connections with the same positioning accuracy benefits as those on cellular connections.

Various aspects relate generally to communication systems. Some aspects more specifically relate to GNSS assistance data over sidelink-based communication for a UE in wireless communication. In some examples, a first UE may be configured to obtain global navigation satellite system (GNSS) assistance data for a sidelink positioning session with one or more second UEs via a sidelink message, calculate, based on the assistance data for the sidelink positioning session, a position of at least one of the first UE or the one or more second UEs, and output an indication indicative of the position of at least one of the first UE or the one or more second UEs.

Particular aspects of the subject matter described in this disclosure can be implemented to realize one or more of the following potential advantages. In some examples, by obtaining GNSS assistance data for a sidelink positioning session with one or more second UEs via the sidelink message, and calculating, based on the assistance data for the sidelink positioning session, a position of at least one of the first UE or the one or more second UEs, the described techniques can be used to provide a signaling mechanism to support communicating positioning data over a sidelink connection of a UE. It enhances positioning accuracy for UEs operating on sidelink connections and improves the efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

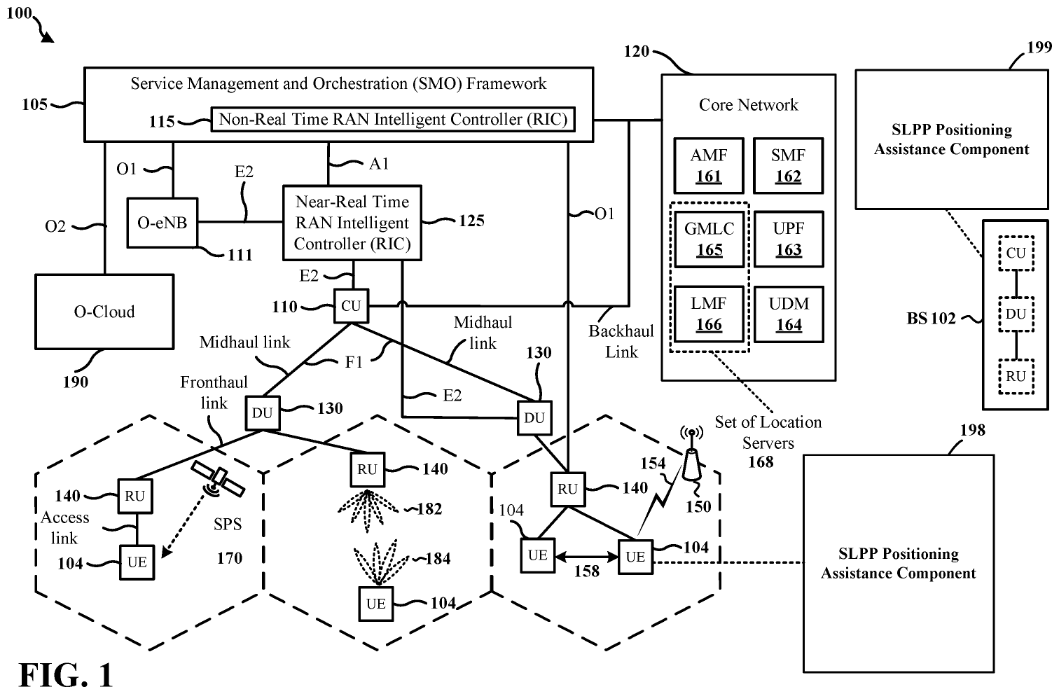

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an SLPP positioning assistance component 198. As used herein, SLPP may refer to the Sidelink Positioning Protocol, which is a UE-to-UE protocol transmitted over PC5 sidelink for the purpose of coordinating and executing sidelink positioning and ranging measurements. SLPP can be transacted between mobile UEs and between mobile and fixed UEs (e.g., roadside units (RSUs)). The SLPP positioning assistance component 198 may be configured to obtain GNSS assistance data for a sidelink positioning session with one or more second UEs via a sidelink message; calculate, based on the GNSS assistance data for the sidelink positioning session, a position of at least one of the first UE or the one or more second UEs; and output an indication indicative of the position of at least one of the first UE or the one or more second UEs. In certain aspects, the base station 102 may include an SLPP positioning assistance component 199. The SLPP positioning assistance component 199 may be configured to configure GNSS assistance data for a sidelink positioning session between a first UE and one or more second UEs; and transmit, for the first UE, the GNSS assistance data for the sidelink positioning session between the first UE and the one or more second UEs. Although the following description may be focused on 5G NR, the concepts described herein may be applicable to other similar areas, such as LTE, LTE-A, CDMA, GSM, and other wireless technologies.

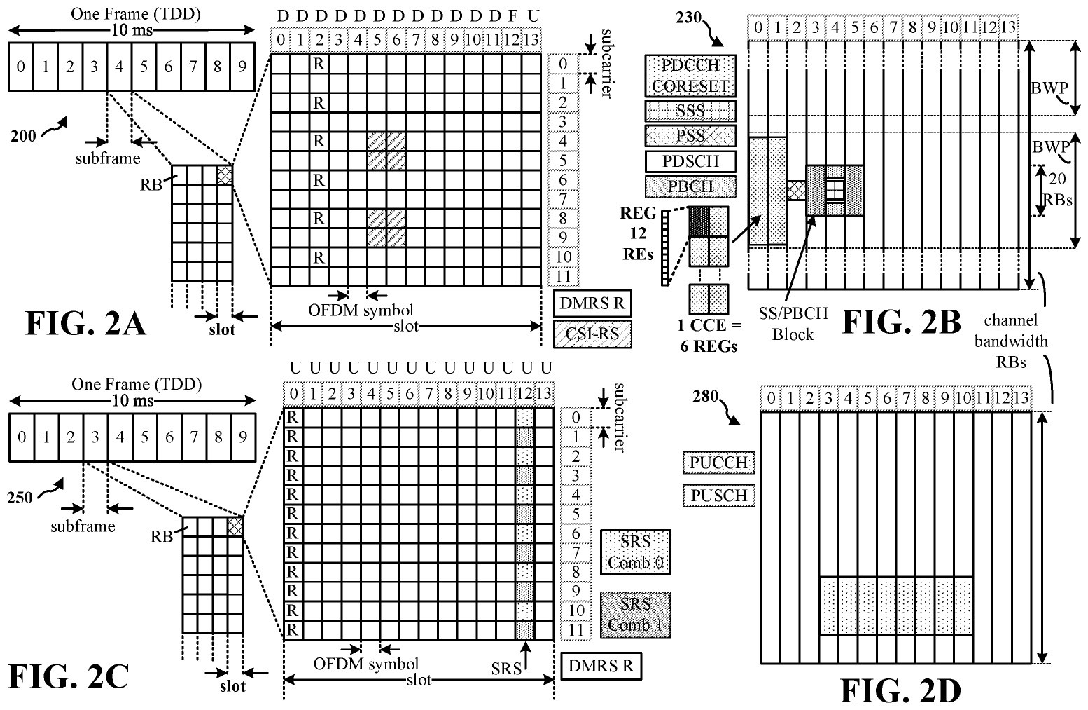

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

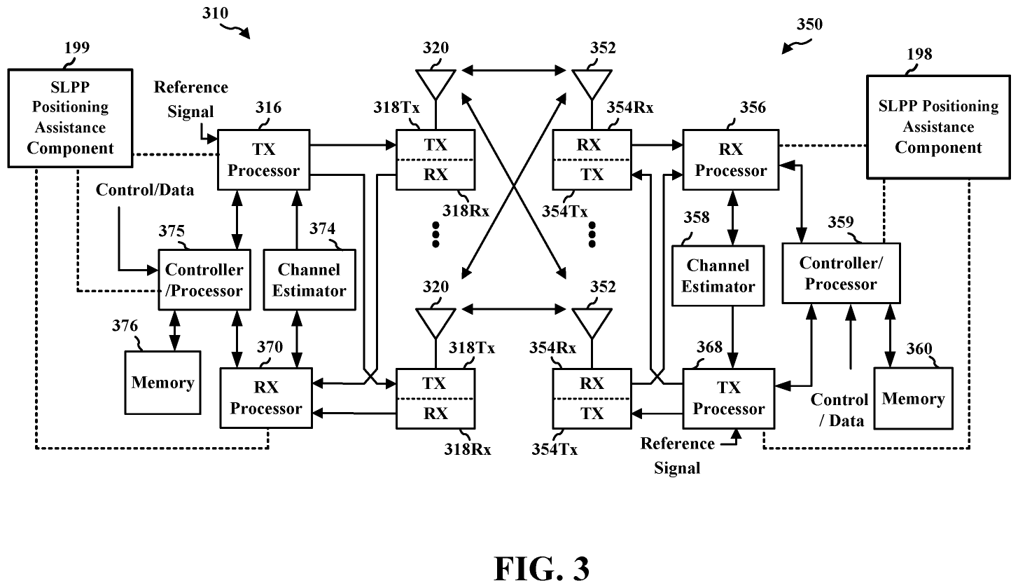

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SLPP positioning assistance component 198 of FIG. 1.

At least one of the TX processor 316, the RX processor 370, and the controller/processor 375 may be configured to perform aspects in connection with the SLPP positioning assistance component 199 of FIG. 1.

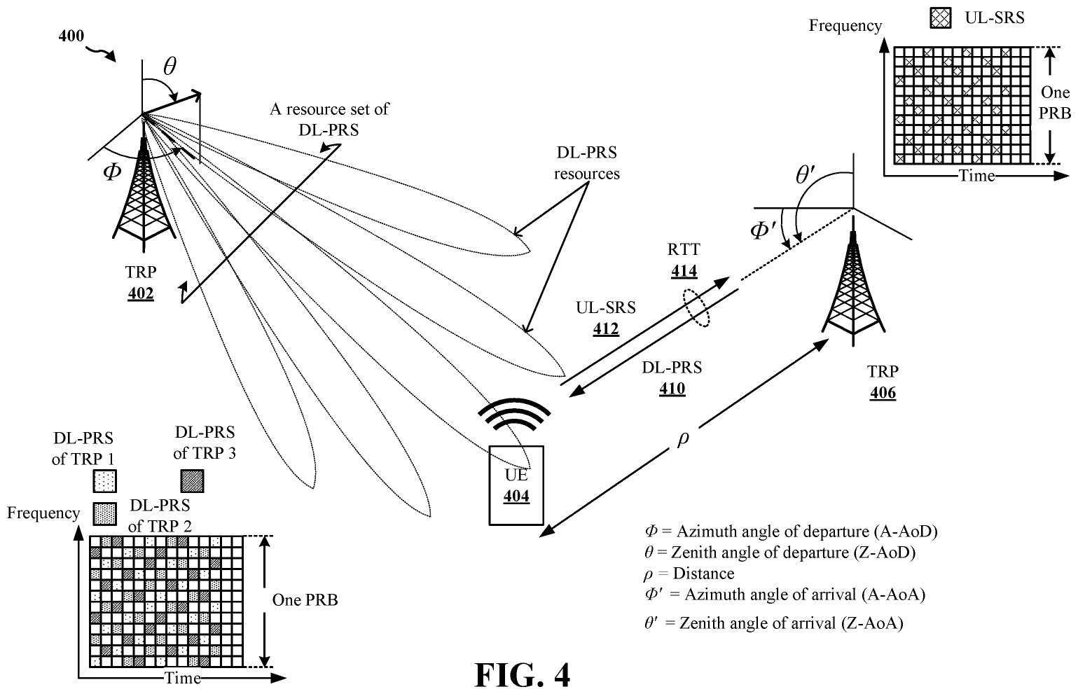

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Cellular connections, such as UE-UTRAN (Uu) connections, may support GNSS assistance data delivery to UEs, enabling improved UE positioning accuracy. Over the Uu connections, GNSS assistance data may be delivered via common signaling or dedicated signaling. A new SLPP may be defined to enable positioning and inter-UE ranging over sidelink (e.g., PC5) for UEs out-of-coverage (OOC) from a network or UEs in-coverage with sidelink-capable infrastructure components such as RSUs. SLPP may support sidelink positioning assistance data transfer between UEs. As used herein, the “GNSS assistance data” refers to the information that may facilitate a device to determine its position using GNSS. The information may include, for example, the information related to the locations of satellites, the location of the device, and the current time.

UEs operating over a sidelink connection may benefit from GNSS assistance data for achieving positioning accuracy in the same manner as UEs operating over a cellular connection. However, no signaling mechanism for GNSS assistance data over sidelink is currently defined. Providing such a signaling mechanism over sidelink, with the flexibility to support unicast, groupcast, and broadcast connections over a sidelink data radio bearer (DRB) or sidelink signaling radio bearer (SRB), will enhance positioning accuracy achievable by sidelink-capable UEs.

The present disclosure provides methods and apparatus for GNSS assistance data over sidelink-based communication for a UE. These mechanisms define signaling pathways to support GNSS assistance data over a sidelink connection, enhancing the positioning capability of the UE. In one aspect, the signaling mechanisms may include support for GNSS assistance data over sidelink unicast, sidelink groupcast, or sidelink broadcast, and support for GNSS assistance data sent over a sidelink DRB or a sidelink SRB. The participating UEs may be mobile or stationary (such as an RSU). In one aspect, the signaling mechanisms may further include mechanisms for signaling overhead reduction when sharing GNSS assistance data over the sidelink.

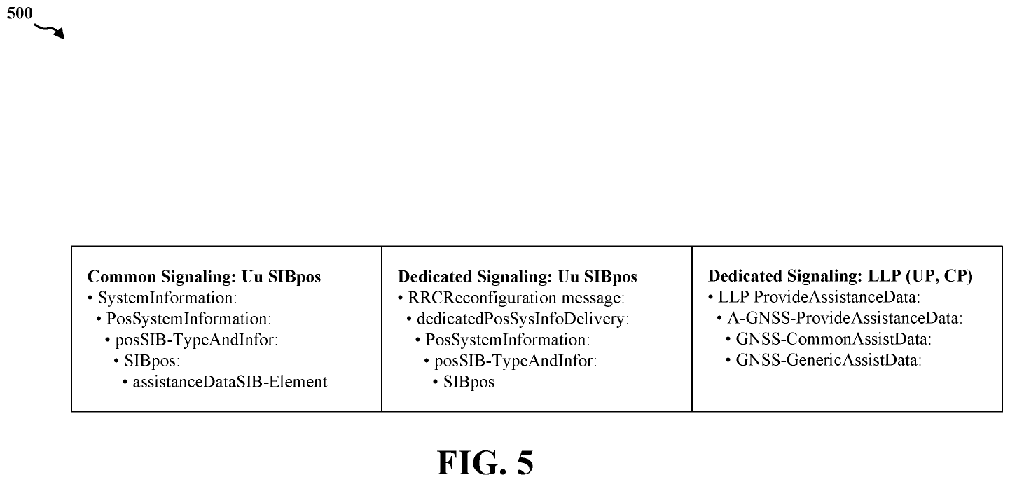

The transmission of GNSS assistance data over a Uu connection may be implemented over common signaling (e.g., via system information (SI)) or dedicated signaling (e.g., via an RRC reconfiguration message RRCReconfiguration). For example, for common signaling, GNSS assistance data in SIBpos information element (IE) may be sent in system information (e.g., via PosSystemInformation-r16 or PosSI-SchedulingInfo). For dedicated signaling. GNSS assistance data may be sent via uplink messages (e.g., DedicatedSIBRequest message) or downlink messages (e.g., RRCReconfiguration message). In one example, GNSS assistance data in SIBpos IE may be sent in the RRCReconfiguration message (e.g., via dedicatedPosSysInfoDelivery-r16). In another example, GNSS assistance data via LTE Positioning Protocol (LPP) IE may be sent via Control Plane (e.g., Evolved Serving Mobile Location Center (E-SMLC)) or Use Plane (e.g., SUPL). FIG. 5 is a diagram 500 illustrating examples of common signaling and dedicated signaling for GNSS assistance data over a Uu connection. In the examples of FIG. 5, for common signaling, the GNSS assistance data may be transmitted via the assistanceDataSIB-Element in the SIBpos IE; for dedicated signaling, the GNSS assistance data may be transmitted via either a downlink message, such as the RRCReconfiguration message, or the LLP IE, such as GNSS-CommonAssistData or GNSS-GenericAssistData, via CP or UP.

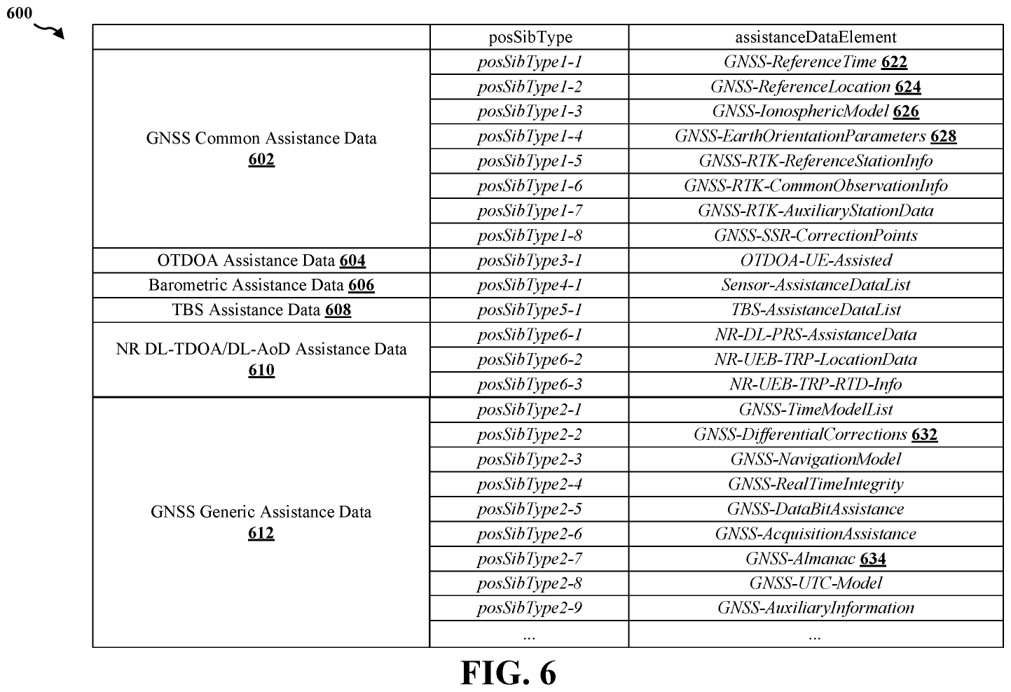

In some aspects, the GNSS assistance data may include GNSS data types and GNSS data elements associated with the GNSS data types. The GNSS data types may include one or more of: GNSS common assistance data, observed time difference of arrival (OTDOA) assistance data, barometric assistance data, time difference of arrival-based system (TBS) assistance data, or New Radio (NR) downlink time difference of arrival/downlink angle of arrival (DL-TDOA/DL-AoD) assistance data. FIG. 6 is a diagram 600 illustrating example GNSS data types and example GNSS data elements associated with the GNSS data types. In FIG. 6, the GNSS assistance data type may include, for example, GNSS common assistance data 602, OTDOA assistance data 604, barometric assistance data 606, TBS assistance data 608, NR DL-TDOA/DL-AoD assistance data 610, and GNSS generic assistance data 612. Each of these GNSS data types may have one or more associated GNSS data elements. For example, as shown in FIG. 6, the GNSS common assistance data 602 may include GNSS data elements of GNSS-ReferenceTime 622, GNSS-ReferenceLocation 624, GNSS-IonosphericModel 626, and GNSS-EarthOrientationParameters 628, among others, and the GNSS generic assistance data 612 may include GNSS data elements of GNSS-DifferentialCorrections 632 and GNSS-Almanac 634, among others.

In some aspects, the GNSS assistance data may be communicated over a sidelink connection. For example, the GNSS assistance data (e.g., PosSystemInformation) may be communicated through SLPP Positioning Assistance Data Exchange (e.g., via a sidelink unicast message, a sidelink groupcast message, or a sidelink broadcast message), and the GNSS assistance data (e.g., PosSystemInformation) may be communicated through sidelink DRB or SRB, for example.

In some aspects, the GNSS assistance data may be communicated through unicast SLPP Positioning Assistance Data Exchange. For example, a sidelink device may obtain SLPP GNSS assistance data in at least one of: a vehicle-to-everything (V2X) layer payload over a sidelink DRB, a packet data convergence protocol (PDCP) service data unit (SDU) over a sidelink signaling radio bearer (SRB), a new PC5-radio resource control (RRC) (PC5-RRC) information element (IE) over a sidelink SRB, or a PC5-sidelink (PC5-S) IE over the sidelink SRB. In some examples, the sidelink device may be the first vehicle, which may obtain the SLPP GNSS assistance data through a sidelink unicast message from another sidelink device, which may be the second vehicle. The first vehicle may obtain the GNSS assistance data from the second vehicle in the payload in the V2X layer over a sidelink DRB, the PDCP SDU over a sidelink SRB, a new PC5-RRC IE over a sidelink SRB, or a PC5-S IE over the sidelink SRB in the sidelink unicast message transmitted from the second vehicle. In some examples, the sidelink devices may be stationary devices, such as the RSUs.

In some aspects, the GNSS assistance data may be communicated through groupcast SLPP Positioning Assistance Data Exchange. For example, a sidelink device may obtain SLPP GNSS assistance data in at least one of: a V2X layer payload over a sidelink DRB, or a PDCP SDU over a sidelink SRB. For example, in the exemplary scenarios where the sidelink devices are sidelink-connected vehicles (e.g., the first vehicle and the second vehicle), the first vehicle may obtain the SLPP GNSS assistance data through a sidelink groupcast message from the second vehicle. The first vehicle may obtain the GNSS assistance data from the second vehicle in the payload in the V2X layer over a sidelink DRB, the PDCP SDU over a sidelink SRB in the sidelink groupcast message. In some examples, the sidelink devices may be sidelink-connected stationary devices, such as sidelink-connected RSUs. In some examples, one sidelink device may be a vehicle and the other sidelink device may be a stationary device that is sidelink-connected to the vehicle, such as a sidelink-connected RSU.

In some aspects, the GNSS assistance data may be communicated through broadcast SLPP Positioning Assistance Data Exchange. For example, a sidelink device may obtain SLPP GNSS assistance data in at least one of: a V2X layer payload over a sidelink DRB, or a PDCP SDU over a sidelink SRB. For example, in the exemplary scenarios where the sidelink devices are sidelink-connected vehicles (e.g., the first vehicle and the second vehicle), the first vehicle may obtain the SLPP GNSS assistance data through a sidelink broadcast message from the second vehicle. The first vehicle may obtain the GNSS assistance data from the second vehicle in the payload in the V2X layer over a sidelink DRB, or the PDCP SDU over a sidelink SRB in the sidelink broadcast message.

In some examples, the GNSS assistance data a sidelink device receives from a sidelink message may include the GNSS assistance data the sidelink device may receive through a Uu connection with a network entity. For example, referring to FIG. 6, the GNSS assistance data the sidelink device may receive from a sidelink message may include one or more of: the GNSS common assistance data 602, the OTDOA assistance data 604, the barometric assistance data 606, the TBS assistance data 608, the NR DL-TDOA/DL-AOD assistance data 610, and the GNSS generic assistance data 612. In some examples, the GNSS assistance data may include the relative positions between the transmitting sidelink device and the receiving sidelink device. The relative positions may include, for example, the relative distance and the relative orientation of one sidelink device with respect to the other sidelink device.

In some examples, the transmission of the sidelink message including the GNSS assistance data between the sidelink devices may be based on one or more preset conditions that may be preconfigured for the sidelink devices. These preset conditions may be set to, for example, reduce the signaling overhead between the transmitting sidelink device and the receiving sidelink device when communicating the GNSS assistance data. In one example, the sidelink message may be transmitted if the transmitting sidelink device is within a certain range of the receiving sidelink device. In another example, the sidelink message including the GNSS assistance data may be transmitted between the transmitting sidelink device and the receiving sidelink device that have an established sidelink session to reduce the signaling overhead.

In some aspects, the sidelink GNSS assistance data may mirror the Uu GNSS assistance data (e.g., PosSystemInformation). In some examples, for GNSS assistance data communicated through unicast SLPP Positioning Assistance Data Exchange, the PC5-RRC IE may be a new IE defined in the sidelink unicast message (e.g., sl-dedicatedPosSysInfoDelivery-r16 carried in the RRCReconfigurationSidelink message), and the PC5-S IE may be new PC5-S IEs defined for GNSS assistance data based on PosSystemInformation. In some examples, for SLPP carried as a V2X payload through unicast, groupcast, or broadcast SLPP Positioning Assistance Data Exchange, the SLPP Positioning Assistance Data Exchange message may incorporate GNSS assistance data based on PosSystemInformation. In some examples, the GNSS assistance data communicated through sidelink may include all of or a portion of the GNSS assistance data communicated through the Uu connection. For example, referring to FIG. 6, the GNSS assistance data communicated through the sidelink unicast message, the sidelink groupcast message, or the sidelink broadcast message may include one or more of: the GNSS common assistance data 602, the OTDOA assistance data 604, the barometric assistance data 606, the TBS assistance data 608, the NR DL-TDOA/DL-AoD assistance data 610, or the GNSS generic assistance data 612.

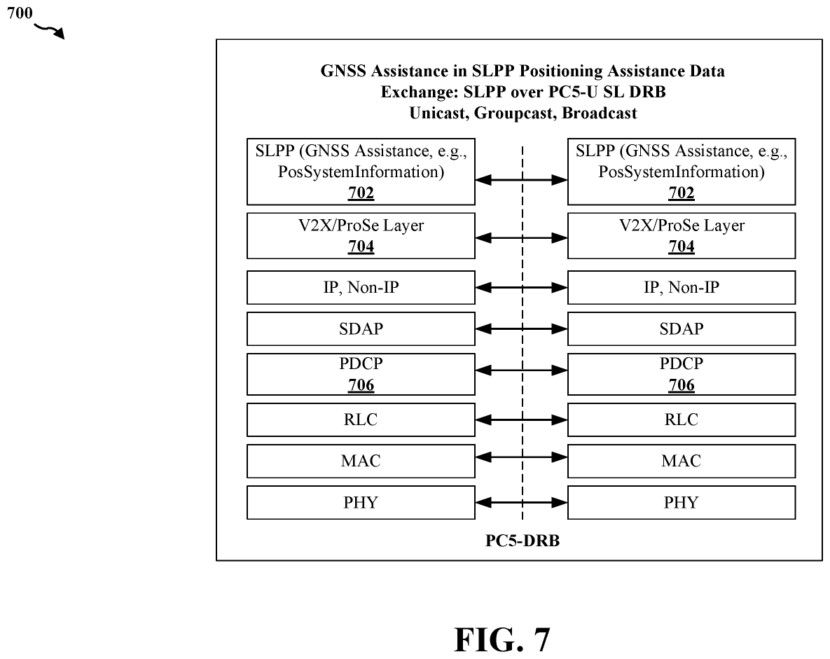

FIG. 7 is a diagram 700 illustrating an example of GNSS assistance data in SLPP Positioning Assistance Data Exchange, with SLPP over PC5-U SL DRB in accordance with various aspects of the present disclosure. In FIG. 7, the GNSS assistance data 702 may be exchanged between sidelink devices over a sidelink DRB, and the sidelink message carrying the GNSS assistance data 702 may be a unicast message, a groupcast message or a broadcast message. The unicast message, the groupcast message, or the broadcast message may be, for example, a payload in the V2X layer 704 over a sidelink DRB, an SDU on the PDCP 706 over a sidelink DRB. Referring to FIG. 6, the GNSS assistance data 702 may include one or more of: the GNSS common assistance data 602, the OTDOA assistance data 604, the barometric assistance data 606, the TBS assistance data 608, the NR DL-TDOA/DL-AOD assistance data 610, or the GNSS generic assistance data 612.

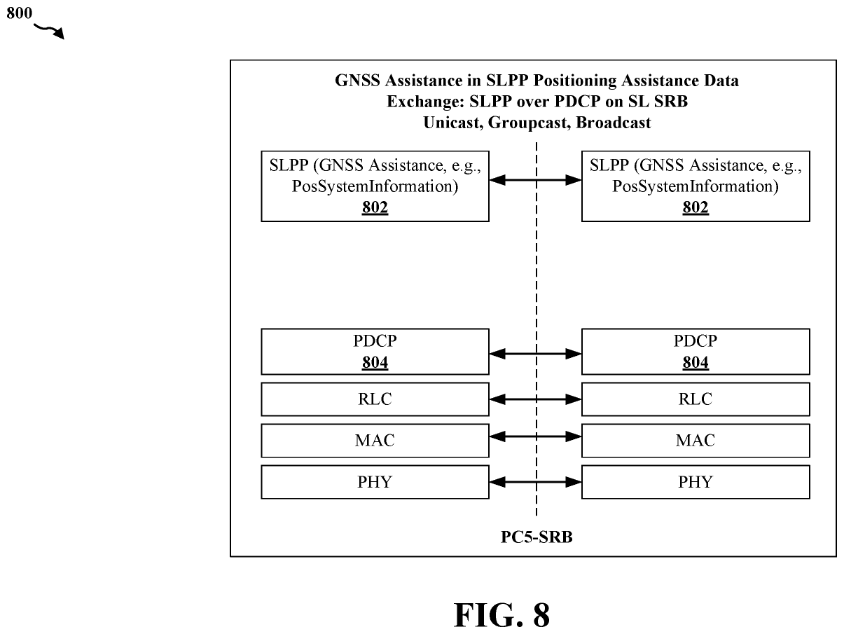

FIG. 8 is a diagram 800 illustrating an example of GNSS assistance data in SLPP Positioning Assistance Data Exchange, with SLPP over PDCP on SL SRB in accordance with various aspects of the present disclosure. In FIG. 8, the GNSS assistance data 802 may be exchanged between sidelink devices over a sidelink SRB, and the sidelink message carrying the GNSS assistance data 802 may be a unicast message, a groupcast message, or a broadcast message. The unicast message, the groupcast message, or the broadcast message may be in, for example, an SDU on the PDCP 804 over a sidelink SRB. Referring to FIG. 6, in one example, the GNSS assistance data 802 may include one or more of: the GNSS common assistance data 602, the OTDOA assistance data 604, the barometric assistance data 606, the TBS assistance data 608, the NR DL-TDOA/DL-AOD assistance data 610, or the GNSS generic assistance data 612.

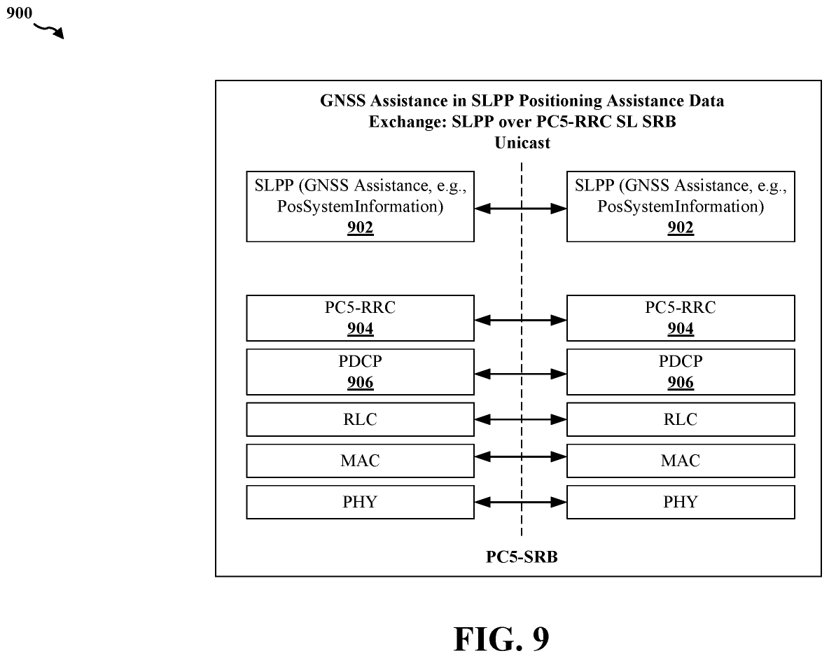

FIG. 9 is a diagram 900 illustrating an example of GNSS assistance data in SLPP Positioning Assistance Data Exchange, with SLPP over PC5-RRC on SL SRB in accordance with various aspects of the present disclosure. In FIG. 9, the GNSS assistance data 902 may be exchanged between sidelink devices over a sidelink SRB, and the message carrying the GNSS assistance data 902 may be a unicast message. The unicast message may be in, for example, a PC5-RRC 904 IE over a sidelink SRB, or an SDU on the PDCP 906 over a sidelink SRB. Referring to FIG. 6, in one example, the GNSS assistance data 902 may include one or more of: the GNSS common assistance data 602, the OTDOA assistance data 604, the barometric assistance data 606, the TBS assistance data 608, the NR DL-TDOA/DL-AOD assistance data 610, or the GNSS generic assistance data 612.

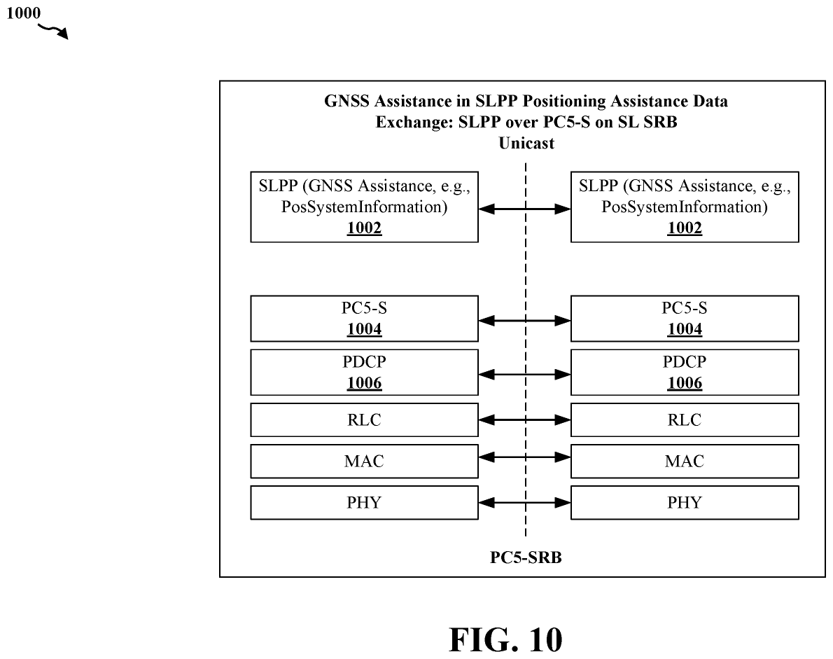

FIG. 10 is a diagram 1000 illustrating an example of GNSS assistance data in SLPP Positioning Assistance Data Exchange, with SLPP over PC5-S on SL SRB in accordance with various aspects of the present disclosure. In FIG. 10, the GNSS assistance data 1002 may be exchanged between sidelink devices over a sidelink SRB, and the message carrying the GNSS assistance data 1002 may be a unicast message. The unicast message may be in, for example, a PC5-S 1004 IE over a sidelink SRB or an SDU on the PDCP 1006 over a sidelink SRB. Referring to FIG. 6, in one example, the GNSS assistance data 1002 may include one or more of: the GNSS common assistance data 602, the OTDOA assistance data 604, the barometric assistance data 606, the TBS assistance data 608, the NR DL-TDOA/DL-AOD assistance data 610, or the GNSS generic assistance data 612.

In some examples, the sidelink devices may be sidelink-connected vehicles. For example, a transmitting sidelink device (e.g., a transmitting vehicle) may transmit a sidelink message including the GNSS assistance data to one or more receiving sidelink devices (e.g., a receiving vehicle) to facilitate the receiving sidelink devices to determine their positions using GNSS. The GNSS assistance data may be included in the sidelink message via one of the mechanisms described in FIGS. 7, 8, 9, and 10. In some examples, the GNSS assistance data may be included in the payload of the V2X layer 704 or the PDCP 706 SDU over a sidelink DRB in a unicast sidelink message, a groupcast sidelink message, or a broadcast sidelink message from a transmitting sidelink device (e.g., a transmitting vehicle) to a receiving sidelink device (e.g., a receiving vehicle). In some examples, the GNSS assistance data may be included in the PDCP 804 SDU over a sidelink SRB in a unicast sidelink message, a groupcast sidelink message, or a broadcast sidelink message from a transmitting sidelink device (e.g., a transmitting vehicle) to a receiving sidelink device (e.g., a receiving vehicle). In some examples, the GNSS assistance data may be included in the PC5-RRC 904 IE or the PDCP 906 SDU over a sidelink SRB in a unicast sidelink message from a transmitting sidelink device (e.g., a transmitting vehicle) to a receiving sidelink device (e.g., a receiving vehicle). In some examples, the GNSS assistance data may be included in a PC5-S 1004 IE or the PDCP 1006 SDU over a sidelink SRB in a unicast sidelink message from a transmitting sidelink device (e.g., a transmitting vehicle) to a receiving sidelink device (e.g., a receiving vehicle). In some examples, the sidelink devices may be sidelink-connected stationary devices, such as sidelink-connected RSUs. In some examples, one of the transmitting and the receiving sidelink devices may be a vehicle and the other of the transmitting and the receiving sidelink devices may be a stationary device, such as a sidelink-connected RSU.

In some examples, the sidelink message may be transmitted from a transmitting sidelink device (e.g., a transmitting vehicle) when a certain preset condition (e.g., when the transmitting and receiving sidelink devices are within a certain range) is met.

In some aspects, the sidelink realization may be implemented via SLPP. SLPP may be defined for the configuration and execution of sidelink positioning and ranging measurements. SLPP may be carried over the PC5 User Plane (PC5-U) as V2X or Proximity Services (ProSe).

Example aspects of the present disclosure utilize the SLPP as a signaling mechanism for sidelink positioning, leveraging the protocol to carry GNSS assistance information. This allows the existing IEs (e.g., the IEs used for GNSS assistance information on Uu connections) to be carried as a payload within SLPP. For example, IEs PosSystemInformation-r16-IEs sent over the Uu connection may be used as IEs sl-PosSystemInformation-r16-IEs over SLPP. Similarly, IEs PosSIB-Type-r16 transmitted over the Uu connections may be used as IEs sl-PosSIB-Type-r16 over SLPP, and DedicatedSIBRequest over the Uu connection may be used as sl-DedicatedSIBRequest over SLPP.

In some aspects, the sidelink realization may be implemented through the utilization of unicast PC5-RRC or PC5-U protocols. To utilize unicast PC5-RRC protocol, for GNSS assistance delivery, a new PC5-RRC message, e.g., sl-PosSystemInformation-r16, may be introduced. The contents of this message may include Uu-based GNSS assistance within PosSystemInformation-IEs-r16. A new PC5-RRC IE, sl-PosSystemInformation-IEs-r16, may be included within the PC5-RRC RRCReconfigurationSidelink message. For GNSS assistance request, a new PC5-RRC message for GNSS assistance requests, e.g., sl-DedicatedSIBRequest-r16, may be introduced. The contents of this new message may include Uu-based GNSS assistance requests found in, for example, DedicatedSIBRequest-r16.

To utilize unicast PC5 signaling (e.g., PC5-S), a new PC5-S message for GNSS assistance delivery, e.g., sl-PosSystemInformation-r16, and a new PC5-S message for GNSS assistance requests, e.g., sl-DedicatedSIBRequest-r16, may be introduced.

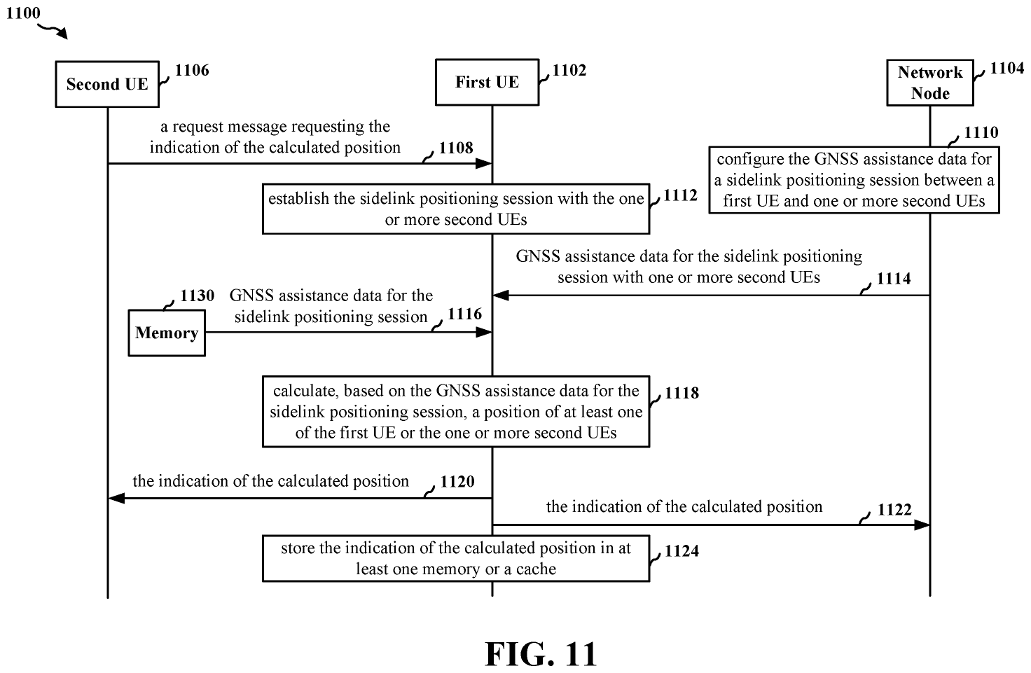

FIG. 11 is a call flow diagram 1100 illustrating a method of wireless communication in accordance with various aspects of this present disclosure. Various aspects are described in connection with a first UE 1102, a network node 1104, and a second UE 1106. These aspects may be performed by the first UE 1102, the network node 1104, or the second UE 1106.

In FIG. 11, the first UE 1102 may, at 1108, receive a request message requesting the indication of a calculated position. In some examples, the first UE 1102 may receive the request message from the second UE 1106.

At 1110, the network node 1104 may configure the GNSS assistance data for a sidelink positioning session between the first UE 1102 and the second UE 1106.

At 1112, the first UE 1102 may establish the sidelink positioning session with the second UE 1106.

The first UE 1102 may obtain, via a sidelink message, GNSS assistance data for a sidelink positioning session with the second UE 1106. In some examples, the first UE 1102 may, at 1114, obtain the GNSS assistance data from the network node 1104. In some examples, the first UE 1102 may, at 1116, obtain the GNSS assistance data from a storage medium, which may be a memory (e.g., the memory 1130) or a cache.

At 1118, the first UE 1102 may calculate the position of at least one of the first UE 1102 or the second UE 1106 based on the GNSS assistance data for the sidelink positioning session.

The first UE 1102 may output an indication of the calculated position of at least one of the first UE 1102 or the second UE 1106. In some examples, at 1120, the first UE 1102 may output the indication to the second UE 1106. In some examples, at 1122, the first UE 1102 may output the indication to the network node 1104. For example, referring to FIG. 7, the first UE may output the indication of the calculated position (e.g., the GNSS assistance data 702) to the second UE over a sidelink DRB. Referring to FIG. 8, the first UE may output the indication of the calculated position (e.g., the GNSS assistance data 802) to the second UE over a sidelink SRB. In some examples, the first UE 1102 may, at 1124, store the indication of the calculated position in at least one memory or a cache.

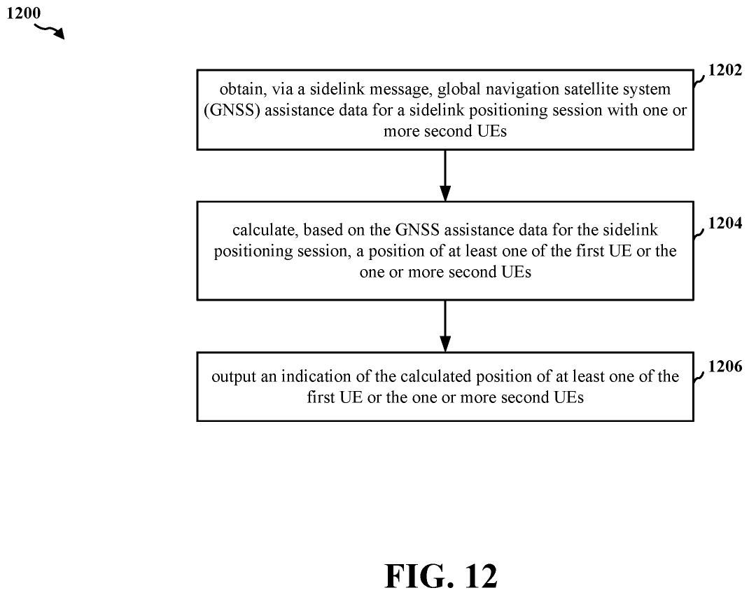

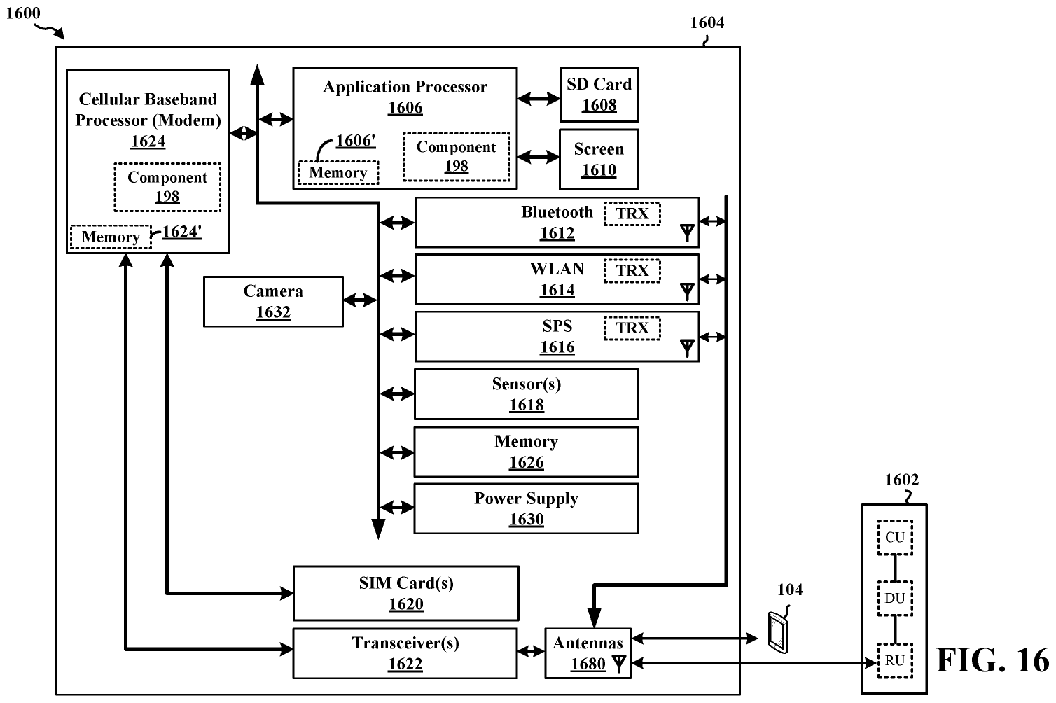

FIG. 12 is a flowchart 1200 illustrating methods of wireless communication at a first UE in accordance with various aspects of the present disclosure. The method may be performed by the first UE. The first UE may be the UE 104, 350, 1102, or the apparatus 1604 in the hardware implementation of FIG. 16. The method provides a signaling mechanism to support communicating positioning data over a sidelink connection of a UE. It enhances positioning accuracy for UEs operating on sidelink connections and improves the efficiency of wireless communication.

As shown in FIG. 12, at 1202, the first UE may obtain, via a sidelink message, GNSS assistance data for a sidelink positioning session with one or more second UEs. FIGS. 7, 8, 9, 10, and 11 illustrate various aspects of the steps in connection with flowchart 1200. For example, referring to FIG. 11, the first UE 1102 may obtain, at 1114, via a sidelink message, GNSS assistance data for a sidelink positioning session, and the sidelink positioning session may be with one or more second UEs (e.g., the second UE 1106). In some aspects, 1202 may be performed by the SLPP positioning assistance component 198.

At 1204, the first UE may calculate, based on the GNSS assistance data for the sidelink positioning session, a position of at least one of the first UE or the one or more second UEs. For example, referring to FIG. 11, the first UE 1102 may calculate, at 1118, based on the GNSS assistance data for the sidelink positioning session, a position of at least one of the first UE 1102 or the one or more second UEs (e.g., the second UE 1106). In some aspects, 1204 may be performed by the SLPP positioning assistance component 198.

At 1206, the first UE may output an indication of the calculated position of at least one of the first UE or the one or more second UEs. In some aspects, the first UE may output the indication to a network node. In some aspects, the network node may be a base station, or a component of a base station, in the access network of FIG. 1 or a core network component (e.g., base station 102, 310; or the network entity 1602 in the hardware implementation of FIG. 16). In some aspects, the network node may be a roadside unit (RSU), a third UE, a sidelink device, or a wireless device. For example, referring to FIG. 11, in some examples, the first UE 1102 may output, at 1122, the indication to a network node 1104; in some examples, the first UE 1102 may output, at 1120, the indication to a second UE (e.g., the second UE 1106). In some aspects, 1206 may be performed by the SLPP positioning assistance component 198.

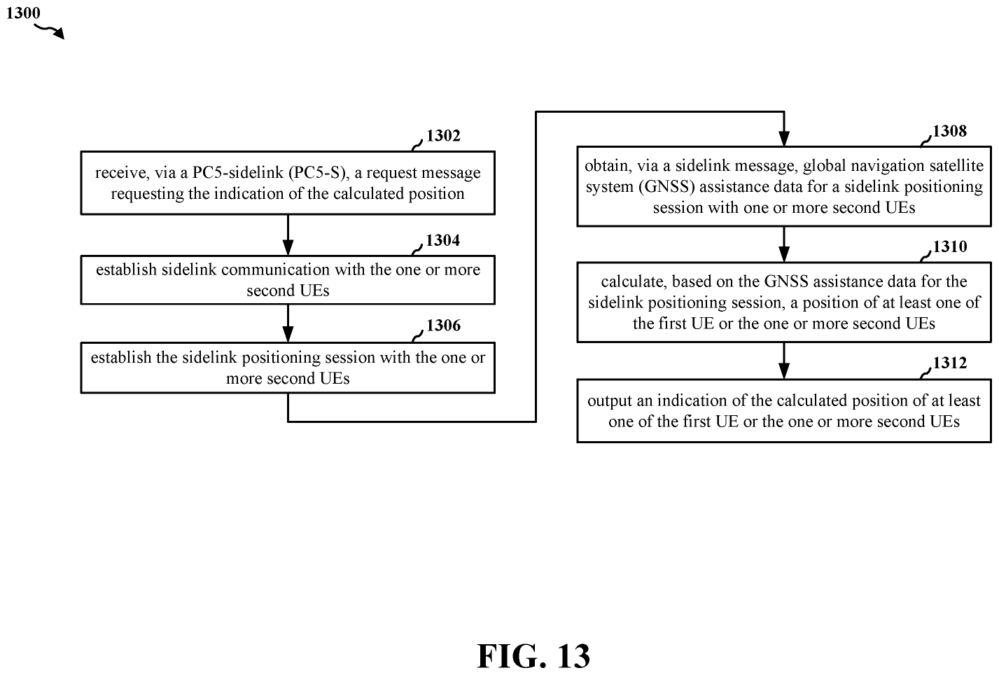

FIG. 13 is a flowchart 1300 illustrating methods of wireless communication at a first UE in accordance with various aspects of the present disclosure. The method may be performed by the first UE. The first UE may be the UE 104, 350, 1102, or the apparatus 1604 in the hardware implementation of FIG. 16. The method provides a signaling mechanism to support communicating positioning data over a sidelink connection of a UE. It enhances positioning accuracy for UEs operating on sidelink connections and improves the efficiency of wireless communication.

As shown in FIG. 13, at 1308, the first UE may obtain, via a sidelink message, GNSS assistance data for a sidelink positioning session with one or more second UEs. FIGS. 7, 8, 9, 10, and 11 illustrate various aspects of the steps in connection with flowchart 1300. For example, referring to FIG. 11, the first UE 1102 may obtain, at 1114, via a sidelink message, GNSS assistance data for a sidelink positioning session, and the sidelink positioning session may be with one or more second UEs (e.g., the second UE 1106). In some aspects, 1308 may be performed by the SLPP positioning assistance component 198.

At 1310, the first UE may calculate, based on the GNSS assistance data for the sidelink positioning session, a position of at least one of the first UE or the one or more second UEs. For example, referring to FIG. 11, the first UE 1102 may calculate, at 1118, based on the GNSS assistance data for the sidelink positioning session, a position of at least one of the first UE 1102 or the one or more second UEs (e.g., the second UE 1106). In some aspects, 1310 may be performed by the SLPP positioning assistance component 198.

At 1312, the first UE may output an indication of the calculated position of at least one of the first UE or the one or more second UEs. In some aspects, the first UE may output the indication to a network node. In some aspects, the network node may be a base station, or a component of a base station, in the access network of FIG. 1 or a core network component (e.g., base station 102, 310; or the network entity 1602 in the hardware implementation of FIG. 16). In some aspects, the network node may be a roadside unit (RSU), a third UE, a sidelink device, or a wireless device. For example, referring to FIG. 11, in some examples, the first UE 1102 may output, at 1122, the indication to a network node 1104; in some examples, the first UE 1102 may output, at 1120, the indication to a second UE (e.g., the second UE 1106). In some aspects, 1312 may be performed by the SLPP positioning assistance component 198.

In some aspects, at 1306, the first UE may establish the sidelink positioning session with the one or more second UEs. To obtain the GNSS assistance data at 1308, the first UE may obtain the GNSS assistance data for the established sidelink positioning session. For example, referring to FIG. 11, the first UE 1102 may establish, at 1112, the sidelink positioning session with the one or more second UEs (e.g., the second UE 1106). In some aspects, 1306 may be performed by the SLPP positioning assistance component 198.

In some aspects, to obtain the GNSS assistance data at 1308, the first UE may obtain the GNSS assistance data for the established sidelink positioning session via one of common signaling or dedicated signaling for the sidelink positioning session. For example, referring to FIG. 11, to obtain the GNSS assistance data, the first UE 1102 may obtain the GNSS assistance data for the established sidelink positioning session via one of common signaling or dedicated signaling for the sidelink positioning session.

In some aspects, the GNSS assistance data may include GNSS data types and GNSS data elements associated with the GNSS data types. For example, referring to FIG. 11, the GNSS assistance data (the first UE 1102 obtained at 1114) may include GNSS data types and GNSS data elements associated with the GNSS data types.

In some aspects, the GNSS data types may include one or more of: GNSS common assistance data, observed time difference of arrival (OTDOA) assistance data, barometric assistance data, time difference of arrival-based system (TBS) assistance data, or New Radio (NR) downlink time difference of arrival/downlink angle of arrival (DL-TDOA/DL-AoD) assistance data. For example, referring to FIG. 11, the GNSS assistance data (at 1114) may include the GNSS data types, and the GNSS data types may include one or more of: GNSS common assistance data, OTDOA assistance data, barometric assistance data, TBS assistance data, or NR DL-TDOA/DL-AoD assistance data. For example, referring to FIG. 6, the GNSS assistance data (at 1114) may include the GNSS data types, and the GNSS data types may include one or more of: GNSS common assistance data 602, OTDOA assistance data 604, barometric assistance data 606, TBS assistance data 608, or NR DL-TDOA/DL-AoD assistance data 610.

In some aspects, at 1302, the first UE may receive, via a PC5-S, a request message requesting the indication of the calculated position. To output the indication of the calculated position at 1312, the first UE may output the indication of the calculated position in response to the request message. For example, referring to FIG. 11, the first UE 1102 may receive, at 1108, via a PC5-S, a request message requesting the indication of the calculated position. To output the indication of the calculated position, the first UE 1102 may output, at 1120, the indication of the calculated position in response to the request message. In some aspects, 1302 may be performed by the SLPP positioning assistance component 198.

In some aspects, at 1304, the first UE may establish sidelink communication with the one or more second UEs. To obtain the GNSS assistance data at 1308, the first UE may obtain the GNSS assistance data for the established sidelink communication. For example, referring to FIG. 11, the first UE 1102 may establish sidelink communication with the one or more second UEs (e.g., the second UE 1106), and the first UE may obtain the GNSS assistance data for the established sidelink communication with the one or more second UEs (e.g., the second UE 1106). In some aspects, 1304 may be performed by the SLPP positioning assistance component 198.

In some aspects, to obtain the GNSS assistance data at 1308, the first UE may receive, from a network node, the GNSS assistance data for the sidelink positioning session. In some aspects, the network node may be a base station, or a component of a base station, in the access network of FIG. 1 or a core network component (e.g., base station 102, 310; or the network entity 1602 in the hardware implementation of FIG. 16). In some aspects, the network node may be a roadside unit (RSU), a third UE, a sidelink device, or a wireless device. For example, referring to FIG. 11, the first UE 1102 may receive, at 1114, from a network node 1104, the GNSS assistance data for the sidelink positioning session.

In some aspects, to obtain the GNSS assistance data at 1308, the first UE may retrieve, from the at least one memory or a cache, the GNSS assistance data for the sidelink positioning session. The at least one memory or the cache may be associated with a positioning application. For example, referring to FIG. 11, the first UE 1102 may retrieve, at 1116, from a memory 1130, the GNSS assistance data for the sidelink positioning session. The memory 1130 may be associated with a positioning application.

In some aspects, to obtain the GNSS assistance data via the sidelink message at 1308, the first UE may obtain the GNSS assistance data via one of a sidelink unicast message, a sidelink groupcast message, or a sidelink broadcast message. For example, referring to FIG. 7, the first UE may obtain the GNSS assistance data (e.g., GNSS common assistance data 602) via one of a sidelink unicast message, a sidelink groupcast message, or a sidelink broadcast message.

In some aspects, the GNSS assistance data that is obtained via the sidelink unicast message, the sidelink groupcast message, or the sidelink broadcast message may mirror second assistance data in an access link with a network node. The second assistance data may be, for example, the GNSS assistance data in the access link. For example, referring to FIG. 11, the first UE 1102 may obtain the GNSS assistance data via the sidelink (e.g., via a sidelink unicast message, a sidelink groupcast message, or a sidelink broadcast message), and the GNSS assistance data may mirror second assistance data in an access link.

In some aspects, to obtain the GNSS assistance data at 1308, the first UE may obtain the GNSS assistance data via the sidelink unicast message. The sidelink unicast message may be in at least one of: a V2X layer payload over a sidelink DRB, a PDCP SDU over a sidelink SRB, a PC5-RRC IE over the sidelink SRB, or a PC5-S IE over the sidelink SRB. For example, referring to FIGS. 7, 8, 9, and 10, the first UE may obtain the GNSS assistance data via the sidelink unicast message. The sidelink unicast message may be in a payload of the V2X layer 704 over a sidelink DRB, an SDU on the PDCP 804 over a sidelink SRB, a PC5-RRC 904 IE over the sidelink SRB, or a PC5-S 1004 IE over a sidelink SRB.

In some aspects, the PC5-RRC IE may be a first new IE defined in the sidelink unicast message, the PC5-S IE may be a second new IE defined in the sidelink unicast message for the GNSS assistance data based on second assistance data in an access link with a network node. The V2X layer payload may incorporate the GNSS assistance data based on the second assistance data in the access link with the network node. For example, referring to FIGS. 7, 9 and 10, the PC5-RRC 904 IE may be a first new IE defined in the sidelink unicast message, the PC5-S 1004 IE may be a second new IE defined in the sidelink unicast message for the GNSS assistance data based on second assistance data in an access link with a network node. The payload on the V2X layer 704 may incorporate the GNSS assistance data based on the second assistance data in an access link.

In some aspects, to obtain the GNSS assistance data at 1308, the first UE may obtain the GNSS assistance data via the sidelink groupcast message. The sidelink groupcast message may be in at least one of: a V2X layer payload over a sidelink DRB, or a PDCP SDU over a sidelink SRB. For example, referring to FIGS. 7 and 8, the sidelink groupcast message may be in the payload of the V2X layer 704 over a sidelink DRB, or an SDU of the PDCP 804 over a sidelink SRB.

In some aspects, the V2X layer payload may incorporate the GNSS assistance data based on second assistance data in an access link with a network node. For example, referring to FIG. 7, the payload of the V2X layer 704 may incorporate the GNSS assistance data based on second assistance data in an access link.

In some aspects, to obtain the GNSS assistance data at 1308, the first UE may obtain the GNSS assistance data via the sidelink broadcast message. The sidelink broadcast message may be in at least one of: a V2X layer payload over a sidelink DRB, or a PDCP SDU over a sidelink SRB. For example, referring to FIGS. 7 and 8, the sidelink broadcast message may be in the payload of the V2X layer 704 over a sidelink DRB, or an SDU of the PDCP 804 over a sidelink SRB.

In some aspects, the V2X layer payload may incorporate the GNSS assistance data based on second assistance data in an access link with a network node. For example, referring to FIG. 7, the payload of the V2X layer 704 may incorporate the GNSS assistance data based on second assistance data in an access link.

In some aspects, the sidelink positioning session may be associated with an SLPP. For example, referring to FIG. 11, the sidelink positioning session (the first UE 1102 established at 1112) may be associated with an SLPP.

In some aspects, to output the indication of the position of at least one of the first UE or the one or more second UEs at 1312, the first UE may transmit, to the one or more second UEs, the indication of the position of at least one of the first UE or the one or more second UEs, or store, in the at least one memory or a cache, the indication of the position of at least one of the first UE or the one or more second UEs. For example, referring to FIG. 11, the first UE 1102 may transmit, at 1120, to the second UE 1106, the indication of the position, or store, at 1124, in the at least one memory or a cache, the indication of the position.

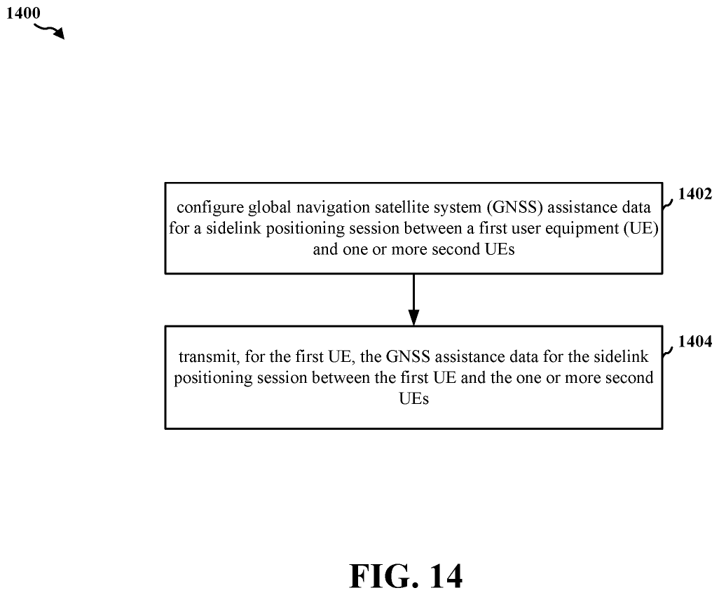

FIG. 14 is a flowchart 1400 illustrating methods of wireless communication at a network node in accordance with various aspects of the present disclosure. The method may be performed by the network node. In some aspects, the network node may be a base station, or a component of a base station, in the access network of FIG. 1 or a core network component (e.g., base station 102, 310; or the network entity 1602 in the hardware implementation of FIG. 16). In some aspects, the network node may be other devices, such as an RSU, a third UE, a sidelink device, or a wireless device. The method provides a signaling mechanism to support communicating positioning data over a sidelink connection of a UE. It enhances positioning accuracy for UEs operating on sidelink connections and improves the efficiency of wireless communication.

As shown in FIG. 14, at 1402, the network node may configure GNSS assistance data for a sidelink positioning session between a first UE and one or more second UEs. The first UE may be the UE 104, 350, 1102, or the apparatus 1604 in the hardware implementation of FIG. 16. The second UE may be, for example, the UE 1106. FIGS. 7, 8, 9, 10, and 11 illustrate various aspects of the steps in connection with flowchart 1400. For example, referring to FIG. 11, the network node 1104 may configure, at 1110, GNSS assistance data for a sidelink positioning session between a first UE 1102 and a second UE 1106. In some aspects, 1402 may be performed by the SLPP positioning assistance component 199.

At 1404, the network node may transmit, for the first UE, the GNSS assistance data for the sidelink positioning session between the first UE and the one or more second UEs. For example, referring to FIG. 11, the network node 1104 may transmit, at 1114, for the first UE 1102, the GNSS assistance data for the sidelink positioning session between the first UE 1102 and the second UE 1106. In some aspects, 1404 may be performed by the SLPP positioning assistance component 199.

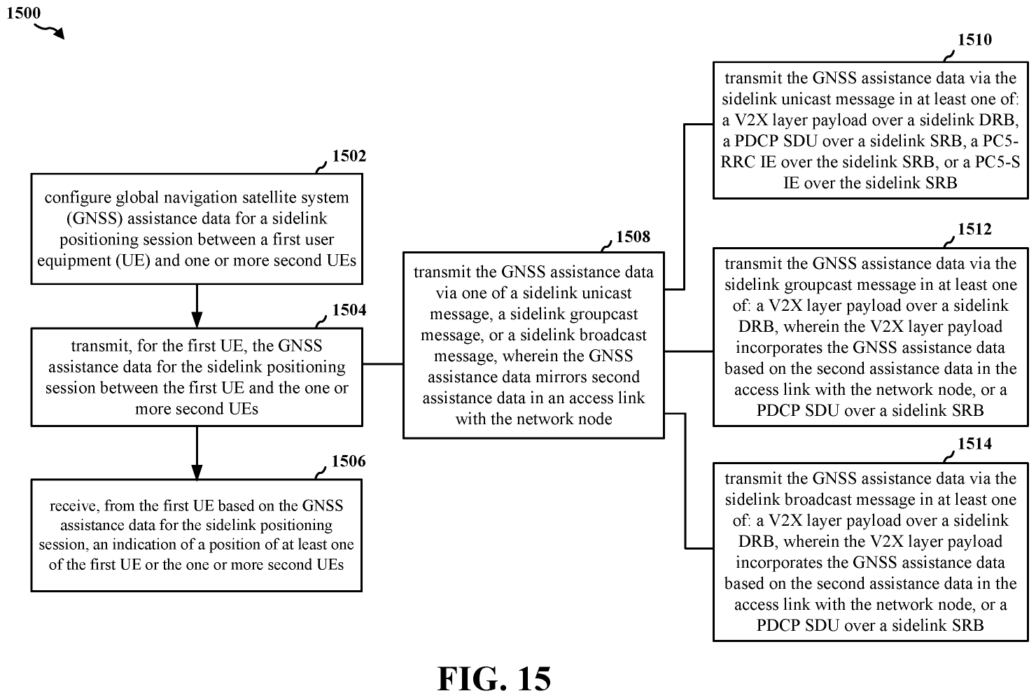

FIG. 15 is a flowchart 1500 illustrating methods of wireless communication at a network node in accordance with various aspects of the present disclosure. The method may be performed by the network node. In some aspects, the network node may be a base station, or a component of a base station, in the access network of FIG. 1 or a core network component (e.g., base station 102, 310; or the network entity 1602 in the hardware implementation of FIG. 16). In some aspects, the network node may be other devices, such as an RSU, a third UE, a sidelink device, or a wireless device. The method provides a signaling mechanism to support communicating positioning data over a sidelink connection of a UE. It enhances positioning accuracy for UEs operating on sidelink connections and improves the efficiency of wireless communication.

As shown in FIG. 15, at 1502, the network node may configure GNSS assistance data for a sidelink positioning session between the first UE and one or more second UEs. The first UE may be the UE 104, 350, 1102, or the apparatus 1604 in the hardware implementation of FIG. 16. The second UE may be, for example, the UE 1106. FIGS. 7, 8, 9, 10, and 11 illustrate various aspects of the steps in connection with flowchart 1500. For example, referring to FIG. 11, the network node 1104 may configure, at 1110, GNSS assistance data for a sidelink positioning session between a first UE 1102 and a second UE 1106. In some aspects, 1502 may be performed by the SLPP positioning assistance component 199.

At 1504, the network node may transmit, for the first UE, the GNSS assistance data for the sidelink positioning session between the first UE and the one or more second UEs. For example, referring to FIG. 11, the network node 1104 may transmit, at 1114, for the first UE 1102, the GNSS assistance data for the sidelink positioning session between the first UE 1102 and the second UE 1106. In some aspects, 1504 may be performed by the SLPP positioning assistance component 199.

In some aspects, the network node may be at least one of: an RSU, a base station, a third UE, a sidelink device, or a wireless device. For example, referring to FIG. 11, the network node 1104 may be at least one of: an RSU, a base station, a third UE, a sidelink device, or a wireless device.

In some aspects, to transmit the GNSS assistance data at 1504, the network node may, at 1508, transmit the GNSS assistance data via one of a sidelink unicast message, a sidelink groupcast message, or a sidelink broadcast message. The GNSS assistance data may mirror second assistance data in an access link with the network node. For example, referring to FIG. 11, to transmit the GNSS assistance data at 1114, the network node 1104 may transmit the GNSS assistance data via one of a sidelink unicast message, a sidelink groupcast message, or a sidelink broadcast message.

In some aspects, to transmit the GNSS assistance data at 1504, the network node may, at 1510, transmit the GNSS assistance data via the sidelink unicast message. The sidelink unicast message may be in at least one of: a V2X layer payload over a sidelink DRB, a PDCP SDU over a sidelink SRB, a PC5-RRC IE over the sidelink SRB, or a PC5-S IE over the sidelink SRB. For example, referring to FIGS. 7, 8, 9, and 10, the sidelink unicast message may be in a payload of the V2X layer 704 over a sidelink DRB, an SDU on the PDCP 804 over a sidelink SRB, a PC5-RRC 904 IE over the sidelink SRB, or a PC5-S 1004 IE over a sidelink SRB.

In some aspects, the PC5-RRC IE may be a first new IE defined in the sidelink unicast message, the PC5-S IE may be a second new IE defined in the sidelink unicast message for the GNSS assistance data based on the second assistance data in the access link with the network node. The V2X layer payload may incorporate the GNSS assistance data based on the second assistance data in the access link with the network node. For example, referring to FIGS. 7, 9 and 10, the PC5-RRC 904 IE may be a first new IE defined in the sidelink unicast message, the PC5-S 1004 IE may be a second new IE defined in the sidelink unicast message for the GNSS assistance data based on second assistance data in an access link with the network node. The payload on the V2X layer 704 may incorporate the GNSS assistance data based on the second assistance data in an access link with the network node.

In some aspects, to transmit the GNSS assistance data at 1504, the network node may, at 1512, transmit the GNSS assistance data via the sidelink groupcast message. The sidelink groupcast message may be in at least one of: a V2X layer payload over a sidelink DRB, where the V2X layer payload may incorporate the GNSS assistance data based on the second assistance data in the access link with the network node, or a PDCP SDU over a sidelink SRB. For example, referring to FIGS. 7 and 8, the sidelink groupcast message may be in the payload of the V2X layer 704 over a sidelink DRB, or an SDU of the PDCP 804 over a sidelink SRB. The payload of the V2X layer 704 may incorporate the GNSS assistance data based on the second assistance data in the access link with the network node.

In some aspects, to transmit the GNSS assistance data at 1504, the network node may, at 1514, transmit the GNSS assistance data via the sidelink broadcast message. The sidelink broadcast message may be in at least one of: a V2X layer payload over a sidelink DRB, where the V2X layer payload may incorporate the GNSS assistance data based on the second assistance data in the access link with the network node, or a PDCP SDU over a sidelink SRB. For example, referring to FIGS. 7 and 8, the sidelink broadcast message may be in the payload of the V2X layer 704 over a sidelink DRB, or an SDU of the PDCP 804 over a sidelink SRB. The payload of the V2X layer 704 may incorporate the GNSS assistance data based on the second assistance data in the access link with the network node.

In some aspects, the sidelink positioning session may be associated with an SLPP, and the network node may, at 1506, receive, from the first UE based on the GNSS assistance data for the sidelink positioning session, an indication of a position of at least one of the first UE or the one or more second UEs. For example, referring to FIG. 11, the sidelink positioning session (the first UE 1102 established at 1112) may be associated with an SLPP. The network node 1104 may, at 1120, receive, from the first UE 1102, based on the GNSS assistance data for the sidelink positioning session, an indication of a position of at least one of the first UE 1102 or the second UE 1106. In some aspects, 1506 may be performed by the SLPP positioning assistance component 199.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 350 of FIG. 3) and include the additional modules of the apparatus 1604.

As discussed supra, the component 198 may be configured to obtain, via a sidelink message, GNSS assistance data for a sidelink positioning session with one or more second UEs; calculate, based on the GNSS assistance data for the sidelink positioning session, a position of at least one of the first UE or the one or more second UEs; and output an indication of the calculated position of at least one of the first UE or the one or more second UEs. The component 198 may be further configured to perform any of the aspects described in connection with the flowcharts in FIG. 12 and FIG. 13, and/or performed by the UE 1102 in FIG. 11. The component 198 may be within the cellular baseband processor(s) 1624, the application processor(s) 1606, or both the cellular baseband processor(s) 1624 and the application processor(s) 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, includes means for obtaining, via a sidelink message, GNSS assistance data for a sidelink positioning session with one or more second UEs, means for calculating, based on the GNSS assistance data for the sidelink positioning session, a position of at least one of the first UE or the one or more second UEs, and means for outputting an indication of the calculated position of at least one of the first UE or the one or more second UEs. The apparatus 1604 may further include means for performing any of the aspects described in connection with the flowcharts in FIG. 12 and FIG. 13, and/or aspects performed by the UE 1102 in FIG. 11. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

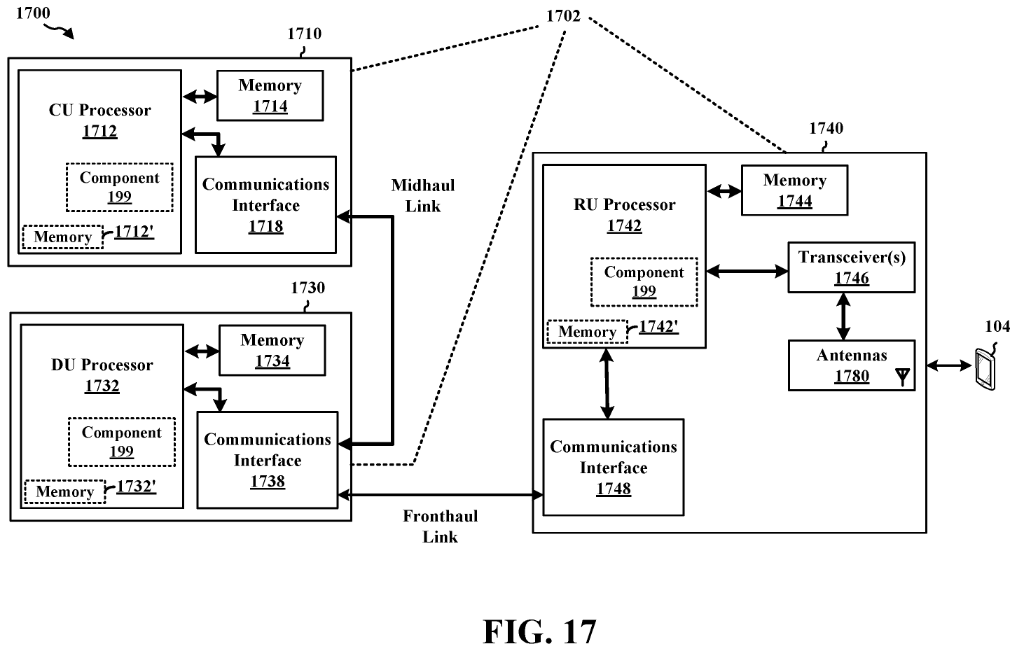

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor 1712. The CU processor(s) 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor 1732. The DU processor(s) 1732 may include on-chip memory 1732′. In some aspects, the DU 1730 may further include additional memory modules 1734 and a communications interface 1738. The DU 1730 communicates with the RU 1740 through a fronthaul link. The RU 1740 may include at least one RU processor 1742. The RU processor(s) 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure GNSS assistance data for a sidelink positioning session between a first UE and one or more second UEs; and transmit, for the first UE, the GNSS assistance data for the sidelink positioning session between the first UE and the one or more second UEs. The component 199 may be further configured to perform any of the aspects described in connection with the flowcharts in FIG. 14 and FIG. 15, and/or performed by the network node 1104 in FIG. 11. The component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 includes means for configuring GNSS assistance data for a sidelink positioning session between a first UE and one or more second UEs, and means for transmitting, for the first UE, the GNSS assistance data for the sidelink positioning session between the first UE and the one or more second UEs. The network entity 1702 may further include means for performing any of the aspects described in connection with the flowcharts in FIG. 14 and FIG. 15, and/or aspects performed by the network node 1104 in FIG. 11. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a first UE. The method may include obtaining, via a sidelink message, GNSS assistance data for a sidelink positioning session with one or more second UEs; calculating, based on the GNSS assistance data for the sidelink positioning session, a position of at least one of the first UE or the one or more second UEs; and outputting an indication of the calculated position of at least one of the first UE or the one or more second UEs. The method provides a signaling mechanism to support communicating positioning data over a sidelink connection of a UE. It enhances positioning accuracy for UEs operating on sidelink connections and improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B. A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative and may be combined with other aspects or teachings described herein, without limitation.

Aspect 1 is a method of wireless communication at a first user equipment (UE). The method may include obtaining, via a sidelink message, global navigation satellite system (GNSS) assistance data for a sidelink positioning session with one or more second UEs; calculating, based on the GNSS assistance data for the sidelink positioning session, a position of at least one of the first UE or the one or more second UEs; and outputting an indication of the calculated position of at least one of the first UE or the one or more second UEs.

Aspect 2 is the method of aspect 1, where the method may further include establishing, prior to the obtainment of the GNSS assistance data, the sidelink positioning session with the one or more second UEs, wherein to obtain the GNSS assistance data, the first UE may be configured to obtain the GNSS assistance data for the established sidelink positioning session.

Aspect 3 is the method of aspect 2, wherein obtaining the GNSS assistance data may include obtaining the GNSS assistance data for the established sidelink positioning session via one of common signaling or dedicated signaling for the sidelink positioning session.

Aspect 4 is the method of aspect 3, wherein the GNSS assistance data may include GNSS data types and GNSS data elements associated with the GNSS data types.

Aspect 5 is the method of aspect 4, wherein the GNSS data types may include one or more of: GNSS common assistance data, observed time difference of arrival (OTDOA) assistance data, barometric assistance data, time difference of arrival-based system (TBS) assistance data, or New Radio (NR) downlink time difference of arrival/downlink angle of arrival (DL-TDOA/DL-AoD) assistance data.

Aspect 6 is the method of any of aspects 1 to 5, wherein the method may further include: receiving, via a PC5-sidelink (PC5-S), a request message requesting the indication of the calculated position, and wherein, outputting the indication of the calculated position may include outputting, in response to the request message, the indication of the calculated position.

Aspect 7 is the method of any of aspects 1 to 6, wherein the method may further include: establishing, prior to the obtainment of the GNSS assistance data, sidelink communication with the one or more second UEs, wherein obtaining the GNSS assistance data may include obtaining the GNSS assistance data for the established sidelink communication.

Aspect 8 is the method of any of aspects 1 to 6, wherein obtaining the GNSS assistance data may include receiving, from a network node, the GNSS assistance data for the sidelink positioning session.

Aspect 9 is the method of aspect 8, wherein the network node may be at least one of: a roadside unit (RSU), a base station, a third UE, a sidelink device, or a wireless device.

Aspect 10 is the method of any of aspects 1 to 6, wherein obtaining the GNSS assistance data may include retrieving, from the at least one memory or a cache, the GNSS assistance data for the sidelink positioning session, wherein the at least one memory or the cache is associated with a positioning application.

Aspect 11 is the method of any of aspects 1 to 6, wherein obtaining the GNSS assistance data via the sidelink message may include obtaining the GNSS assistance data via one of a sidelink unicast message, a sidelink groupcast message, or a sidelink broadcast message.

Aspect 12 is the method of aspect 11, wherein the GNSS assistance data that is obtained via the sidelink unicast message, the sidelink groupcast message, or the sidelink broadcast message may mirror second assistance data in an access link with a network node.

Aspect 13 is the method of aspect 11, wherein obtaining the GNSS assistance data may include obtaining the GNSS assistance data via the sidelink unicast message in at least one of: a vehicle-to-everything (V2X) layer payload over a sidelink data radio bearer (DRB), a packet data convergence protocol (PDCP) service data unit (SDU) over a sidelink signaling radio bearer (SRB), a PC5-radio resource control (RRC) (PC5-RRC) information element (IE) over the sidelink SRB, or a PC5-sidelink (PC5-S) IE over the sidelink SRB.

Aspect 14 is the method of aspect 13, wherein the PC5-RRC IE may be a first new IE defined in the sidelink unicast message, the PC5-S IE may be a second new IE defined in the sidelink unicast message for the GNSS assistance data based on second assistance data in an access link with a network node, and wherein the V2X layer payload may incorporate the GNSS assistance data based on the second assistance data in the access link with the network node.

Aspect 15 is the method of aspect 11, wherein obtaining the GNSS assistance data may include obtaining the GNSS assistance data via the sidelink groupcast message in at least one of: a vehicle-to-everything (V2X) layer payload over a sidelink data radio bearer (DRB), or a packet data convergence protocol (PDCP) service data unit (SDU) over a sidelink signaling radio bearer (SRB).

Aspect 16 is the method of aspect 15, wherein the V2X layer payload may incorporate the GNSS assistance data based on second assistance data in an access link with a network node.

Aspect 17 is the method of aspect 11, wherein obtaining the GNSS assistance data may include obtaining the GNSS assistance data via the sidelink broadcast message in at least one of: a vehicle-to-everything (V2X) layer payload over a sidelink data radio bearer (DRB), or a packet data convergence protocol (PDCP) service data unit (SDU) over a sidelink signaling radio bearer (SRB).

Aspect 18 is the method of aspect 17, wherein the V2X layer payload may incorporate the GNSS assistance data based on second assistance data in an access link with a network node.

Aspect 19 is the method of any of aspects 1 to 18, wherein the sidelink positioning session may be associated with a sidelink positioning protocol (SLPP).

Aspect 20 is the method of any of aspects 1 to 19, wherein outputting the indication of the position of at least one of the first UE or the one or more second UEs may include transmitting, to the one or more second UEs, the indication of the position of at least one of the first UE or the one or more second UEs, or storing, in the at least one memory or a cache, the indication of the position of at least one of the first UE or the one or more second UEs.

Aspect 21 is an apparatus for wireless communication at a UE, including: at least one memory; and at least one processor coupled to the at least one memory and, based at least in part on information stored in the at least one memory, the at least one processor, individually or in any combination, is configured to perform the method of any of aspects 1-20.

Aspect 22 is the apparatus of aspect 21, further including at least one of a transceiver or an antenna coupled to the at least one processor and configured to obtain the GNSS assistance data.

Aspect 23 is an apparatus for wireless communication including means for implementing the method of any of aspects 1-20.

Aspect 24 is a computer-readable medium (e.g., a non-transitory computer-readable medium) storing computer executable code, where the code when executed by at least one processor causes the at least one processor to implement the method of any of aspects 1-20.

Aspect 25 is a method of wireless communication at a network node. The method may include configuring global navigation satellite system (GNSS) assistance data for a sidelink positioning session between a first user equipment (UE) and one or more second UEs; and transmitting, for the first UE, the GNSS assistance data for the sidelink positioning session between the first UE and the one or more second UEs.

Aspect 26 is the method of aspect 25, wherein the network node may be at least one of: a roadside unit (RSU), a base station, a third UE, a sidelink device, or a wireless device.

Aspect 27 is the method of any of aspects 25 to 26, wherein transmitting the GNSS assistance data may include transmitting the GNSS assistance data via one of a sidelink unicast message, a sidelink groupcast message, or a sidelink broadcast message, wherein the GNSS assistance data may mirror second assistance data in an access link with the network node.

Aspect 28 is the method of aspect 27, wherein transmitting the GNSS assistance data may include transmitting the GNSS assistance data via the sidelink unicast message in at least one of: a vehicle-to-everything (V2X) layer payload over a sidelink data radio bearer (DRB), a packet data convergence protocol (PDCP) service data unit (SDU) over a sidelink signaling radio bearer (SRB), a PC5-radio resource control (RRC) (PC5-RRC) information element (IE) over the sidelink SRB, or a PC5-sidelink (PC5-S) IE over the sidelink SRB.

Aspect 29 is the method of aspect 28, wherein the PC5-RRC IE may be a first new IE defined in the sidelink unicast message, the PC5-S IE may be a second new IE defined in the sidelink unicast message for the GNSS assistance data based on the second assistance data in the access link with the network node, and wherein the V2X layer payload may incorporate the GNSS assistance data based on the second assistance data in the access link with the network node.

Aspect 30 is the method of aspect 27, wherein transmitting the GNSS assistance data may include transmitting the GNSS assistance data via the sidelink groupcast message in at least one of: a vehicle-to-everything (V2X) layer payload over a sidelink data radio bearer (DRB), wherein the V2X layer payload may incorporate the GNSS assistance data based on the second assistance data in the access link with the network node, or a packet data convergence protocol (PDCP) service data unit (SDU) over a sidelink signaling radio bearer (SRB).

Aspect 31 is the method of aspect 27, wherein transmitting the GNSS assistance data may include transmitting the GNSS assistance data via the sidelink broadcast message in at least one of: a vehicle-to-everything (V2X) layer payload over a sidelink data radio bearer (DRB), wherein the V2X layer payload may incorporate the GNSS assistance data based on the second assistance data in the access link with the network node, or a packet data convergence protocol (PDCP) service data unit (SDU) over a sidelink signaling radio bearer (SRB).

Aspect 32 is the method of any of aspects 25 to 31, wherein the sidelink positioning session may be associated with a sidelink positioning protocol (SLPP), and wherein the method may further include receiving, from the first UE based on the GNSS assistance data for the sidelink positioning session, an indication of a position of at least one of the first UE or the one or more second UEs.

Aspect 33 is an apparatus for wireless communication at a network node, including: at least one memory; and at least one processor coupled to the at least one memory and, based at least in part on information stored in the at least one memory, the at least one processor, individually or in any combination, is configured to perform the method of any of aspects 25-32.

Aspect 34 is the apparatus of aspect 33, further including at least one of a transceiver or an antenna coupled to the at least one processor and configured to transmit the GNSS assistance data.

Aspect 35 is an apparatus for wireless communication including means for implementing the method of any of aspects 25-32.

Aspect 36 is a computer-readable medium (e.g., a non-transitory computer-readable medium) storing computer executable code, where the code when executed by at least one processor causes the at least one processor to implement the method of any of aspects 25-32.

What is claimed is:

1. An apparatus for wireless communication at a first user equipment (UE), comprising:
at least one memory; and
at least one processor coupled to the at least one memory and, based at least in part on information stored in the at least one memory, the at least one processor, individually or in any combination, is configured to:
obtain, via a sidelink message, global navigation satellite system (GNSS) assistance data for a sidelink positioning session with one or more second UEs;
calculate, based on the GNSS assistance data for the sidelink positioning session, a position of at least one of the first UE or the one or more second UEs; and
output an indication of the calculated position of at least one of the first UE or the one or more second UEs.

2. The apparatus of claim 1, further comprising a transceiver coupled to the at least one processor, wherein, to obtain the GNSS assistance data, the at least one processor, individually or in any combination, is configured to receive the GNSS assistance data via the transceiver, and wherein the at least one processor, individually or in any combination, is further configured to:
establish, prior to the obtainment of the GNSS assistance data, the sidelink positioning session with the one or more second UEs, wherein to obtain the GNSS assistance data, the at least one processor, individually or in any combination, is configured to obtain the GNSS assistance data for the established sidelink positioning session.

3. The apparatus of claim 2, wherein to obtain the GNSS assistance data, the at least one processor, individually or in any combination, is configured to obtain the GNSS assistance data for the established sidelink positioning session via one of common signaling or dedicated signaling for the sidelink positioning session.

4. The apparatus of claim 3, wherein the GNSS assistance data includes GNSS data types and GNSS data elements associated with the GNSS data types.

5. The apparatus of claim 4, wherein the GNSS data types include one or more of:
GNSS common assistance data,
observed time difference of arrival (OTDOA) assistance data,
barometric assistance data,
time difference of arrival-based system (TBS) assistance data, or
New Radio (NR) downlink time difference of arrival/downlink angle of arrival (DL-TDOA/DL-AoD) assistance data.

6. The apparatus of claim 1, wherein the at least one processor, individually or in any combination, is further configured to:
receive, via a PC5-sidelink (PC5-S), a request message requesting the indication of the calculated position, and wherein, to output the indication of the calculated position, the at least one processor, individually or in any combination, is configured to:
output, in response to the request message, the indication of the calculated position.

7. The apparatus of claim 1, wherein the at least one processor, individually or in any combination, is further configured to:
establish, prior to the obtainment of the GNSS assistance data, sidelink communication with the one or more second UEs, wherein to obtain the GNSS assistance data, the at least one processor, individually or in any combination, is configured to obtain the GNSS assistance data for the established sidelink communication.

8. The apparatus of claim 1, wherein, to obtain the GNSS assistance data, the at least one processor, individually or in any combination, is configured to:
receive, from a network node, the GNSS assistance data for the sidelink positioning session.

9. The apparatus of claim 8, wherein the network node is at least one of:
a roadside unit (RSU),
a base station,
a third UE,
a sidelink device, or
a wireless device.

10. The apparatus of claim 1, wherein, to obtain the GNSS assistance data, the at least one processor, individually or in any combination, is configured to:
retrieve, from the at least one memory or a cache, the GNSS assistance data for the sidelink positioning session, wherein the at least one memory or the cache is associated with a positioning application.

11. The apparatus of claim 1, wherein, to obtain the GNSS assistance data via the sidelink message, the at least one processor, individually or in any combination, is configured to:
obtain the GNSS assistance data via one of a sidelink unicast message, a sidelink groupcast message, or a sidelink broadcast message.

12. The apparatus of claim 11, wherein the GNSS assistance data that is obtained via the sidelink unicast message, the sidelink groupcast message, or the sidelink broadcast message mirrors second assistance data in an access link with a network node.

13. The apparatus of claim 11, wherein, to obtain the GNSS assistance data, the at least one processor, individually or in any combination, is further configured to: obtain the GNSS assistance data via the sidelink unicast message in at least one of:
a vehicle-to-everything (V2X) layer payload over a sidelink data radio bearer (DRB),
a packet data convergence protocol (PDCP) service data unit (SDU) over a sidelink signaling radio bearer (SRB),
a PC5-radio resource control (RRC) (PC5-RRC) information element (IE) over the sidelink SRB, or
a PC5-sidelink (PC5-S) IE over the sidelink SRB.

14. The apparatus of claim 13, wherein the PC5-RRC IE is a first new IE defined in the sidelink unicast message, the PC5-S IE is a second new IE defined in the sidelink unicast message for the GNSS assistance data based on second assistance data in an access link with a network node, and wherein the V2X layer payload incorporates the GNSS assistance data based on the second assistance data in the access link with the network node.

15. The apparatus of claim 11, wherein, to obtain the GNSS assistance data, the at least one processor, individually or in any combination, is configured to: obtain the GNSS assistance data via the sidelink groupcast message in at least one of:
a vehicle-to-everything (V2X) layer payload over a sidelink data radio bearer (DRB), or
a packet data convergence protocol (PDCP) service data unit (SDU) over a sidelink signaling radio bearer (SRB).

16. The apparatus of claim 15, wherein the V2X layer payload incorporates the GNSS assistance data based on second assistance data in an access link with a network node.

17. The apparatus of claim 11, wherein, to obtain the GNSS assistance data, the at least one processor, individually or in any combination, is configured to: obtain the GNSS assistance data via the sidelink broadcast message in at least one of:
a vehicle-to-everything (V2X) layer payload over a sidelink data radio bearer (DRB), or
a packet data convergence protocol (PDCP) service data unit (SDU) over a sidelink signaling radio bearer (SRB).

18. The apparatus of claim 17, wherein the V2X layer payload incorporates the GNSS assistance data based on second assistance data in an access link with a network node.

19. The apparatus of claim 1, wherein the sidelink positioning session is associated with a sidelink positioning protocol (SLPP).

20. The apparatus of claim 1, wherein, to output the indication of the position of at least one of the first UE or the one or more second UEs, the at least one processor, individually or in any combination, is configured to:
transmit, to the one or more second UEs, the indication of the position of at least one of the first UE or the one or more second UEs, or
store, in the at least one memory or a cache, the indication of the position of at least one of the first UE or the one or more second UEs.

21. An apparatus for wireless communication at a network node, comprising:
at least one memory; and
at least one processor coupled to the at least one memory and, based at least in part on information stored in the at least one memory, the at least one processor, individually or in any combination, is configured to:
configure global navigation satellite system (GNSS) assistance data for a sidelink positioning session between a first user equipment (UE) and one or more second UEs; and
transmit, for the first UE, the GNSS assistance data for the sidelink positioning session between the first UE and the one or more second UEs.

22. The apparatus of claim 21, further comprising a transceiver coupled to the at least one processor, wherein, to transmit the GNSS assistance data, the at least one processor, individually or in any combination, is configured to transmit the GNSS assistance data via the transceiver, and wherein the network node is at least one of:
a roadside unit (RSU),
a base station,
a third UE,
a sidelink device, or
a wireless device.

23. The apparatus of claim 21, wherein, to transmit the GNSS assistance data, the at least one processor, individually or in any combination, is configured to:
transmit the GNSS assistance data via one of a sidelink unicast message, a sidelink groupcast message, or a sidelink broadcast message, wherein the GNSS assistance data mirrors second assistance data in an access link with the network node.

24. The apparatus of claim 23, wherein, to transmit the GNSS assistance data, the at least one processor, individually or in any combination, is configured to: transmit the GNSS assistance data via the sidelink unicast message in at least one of:
a vehicle-to-everything (V2X) layer payload over a sidelink data radio bearer (DRB),
a packet data convergence protocol (PDCP) service data unit (SDU) over a sidelink signaling radio bearer (SRB),
a PC5-radio resource control (RRC) (PC5-RRC) information element (IE) over the sidelink SRB, or
a PC5-sidelink (PC5-S) IE over the sidelink SRB.

25. The apparatus of claim 24, wherein the PC5-RRC IE is a first new IE defined in the sidelink unicast message, the PC5-S IE is a second new IE defined in the sidelink unicast message for the GNSS assistance data based on the second assistance data in the access link with the network node, and wherein the V2X layer payload incorporates the GNSS assistance data based on the second assistance data in the access link with the network node.

26. The apparatus of claim 23, wherein, to transmit the GNSS assistance data, the at least one processor, individually or in any combination, is configured to: transmit the GNSS assistance data via the sidelink groupcast message in at least one of:
a vehicle-to-everything (V2X) layer payload over a sidelink data radio bearer (DRB), wherein the V2X layer payload incorporates the GNSS assistance data based on the second assistance data in the access link with the network node, or
a packet data convergence protocol (PDCP) service data unit (SDU) over a sidelink signaling radio bearer (SRB).

27. The apparatus of claim 23, wherein, to transmit the GNSS assistance data, the at least one processor, individually or in any combination, is configured to: transmit the GNSS assistance data via the sidelink broadcast message in at least one of:
a vehicle-to-everything (V2X) layer payload over a sidelink data radio bearer (DRB), wherein the V2X layer payload incorporates the GNSS assistance data based on the second assistance data in the access link with the network node, or
a packet data convergence protocol (PDCP) service data unit (SDU) over a sidelink signaling radio bearer (SRB).

28. The apparatus of claim 21, wherein the sidelink positioning session is associated with a sidelink positioning protocol (SLPP), and wherein the at least one processor, individually or in any combination, is further configured to:
receive, from the first UE based on the GNSS assistance data for the sidelink positioning session, an indication of a position of at least one of the first UE or the one or more second UEs.

29. A method of wireless communication at a first user equipment (UE), comprising:
obtaining, via a sidelink message, global navigation satellite system (GNSS) assistance data for a sidelink positioning session with one or more second UEs;
calculating, based on the GNSS assistance data for the sidelink positioning session, a position of at least one of the first UE or the one or more second UEs; and
outputting an indication of the calculated position of at least one of the first UE or the one or more second UEs.

30. A method of wireless communication at a network node, comprising:
configuring global navigation satellite system (GNSS) assistance data for a sidelink positioning session between a first user equipment (UE) and one or more second UEs; and
transmitting, for the first UE, the GNSS assistance data for the sidelink positioning session between the first UE and the one or more second UEs.
